(19) United States
(12) Patent Application Publication
(10) Pub. No.: US 2026/0213401 A1
(43) Pub. Date: Jul. 23, 2026

(54) Antenna Unit And Door Handle

(71) Applicant: SUMIDA CORPORATION, Tokyo (JP)

(72) Inventor: Noriaki IWASAKI, Natori City (JP)

(21) Appl. No.: 19/569,163

(22) Filed: Mar. 17, 2026

Related U.S. Application Data
(63) Continuation of application No. PCT/JP2023/035176, filed on Sep. 27, 2023.

(51) Int. Cl. H01Q 1/32; H01Q 7/08

(52) U.S. Cl. CPC H01Q 1/3283; H01Q 7/08

(57) ABSTRACT

Provided is a long antenna unit to be connected to an external circuit board. The antenna unit includes an antenna section and a bendable section. In the antenna section, a coil wire is wound around a core. The bendable section is capable of bending in a bending direction. The bending direction is a direction intersecting a longitudinal direction of the antenna unit. When a force is applied to the antenna unit so as to bend the antenna unit as a whole in one direction in the bending direction, the bendable section can bend to a greater degree than the core in the one direction.

### CROSS REFERENCE TO RELATED APPLICATIONS

This application claims priority to International Patent Application No. PCT/JP2023/035176, filed on Sep. 27, 2023, which is expressly incorporated herein by reference in its entirety.

### BACKGROUND

### Technical Field

The present invention relates to an antenna unit and a door handle having the antenna unit.

### Related Art

Some antenna units are arranged in an enclosure, such as of a door handle, which is long in a longitudinal direction. In relation to this type of technology, Japanese Patent Laid-Open No. 2017-204675 (Patent Literature 1) discloses an antenna unit (100) to be used in a state loaded in a door handle (200). The antenna unit (100) includes a plurality of antenna sections (10), the antenna sections (10) each having a core (11) and a coil (12) wound around the core (11). The cores (11) of the plurality of antenna sections (10) are spaced from one another.

A long enclosure may deform with stress applied temporarily or for a predetermined period in a predetermined direction intersecting a longitudinal direction. For example, in the case of a door handle, the door handle may bend and deform by pulling of the door handle in association with a door opening/closing operation or the like. When the long enclosure deforms, an antenna unit arranged inside the member may also deform in association with the deformation.

At this time, deformation of the antenna sections, an occurrence of cracking of the cores, or the like due to the deformation of the antenna unit causes a problem in that the antenna unit deteriorates in function.

The present invention has been made in view of the problems as described above, and provides an antenna unit that reduces deterioration in function of the antenna unit, which would be caused by deformation of an enclosure, and a door handle with the antenna unit loaded therein.

### SUMMARY

An antenna unit of the present invention is an antenna unit which is long and is to be connected to an external circuit board, the antenna unit including: an antenna section in which a coil wire is wound around a core; and a bendable section capable of bending in a bending direction intersecting a longitudinal direction of the antenna unit, in which when a force is applied to the antenna unit so as to bend the antenna unit as a whole in one direction in the bending direction, the bendable section can bend to a greater degree than the core in the one direction.

A door handle of the present invention is a door handle to be provided for a door and to be pulled in a predetermined pulling direction to allow the door to be opened, the door handle including: a circuit board; an antenna unit which is long and is to be connected to the circuit board; and a housing that houses the circuit board and the antenna unit, in which the antenna unit includes an antenna section in which a coil wire is wound around a core, and a bendable section capable of bending in a bending direction intersecting a longitudinal direction of the antenna unit, and when a force is applied to the antenna unit so as to bend the antenna unit as a whole in one direction in the bending direction, the bendable section can bend to a greater degree than the core in the one direction.

Since the bendable section can bend to a greater degree than the core in one direction in the bending direction, the bendable section will bend prior to the core when the antenna unit is going to bend with stress applied to the enclosure such as of the door handle. Accordingly, cracking of the core, deformation of the antenna section having the core, or the like is reduced.

### Effect of the Invention

With the antenna unit of the present invention, the bendable section bends in response to deformation of the enclosure to reduce cracking of the core or deformation of the antenna section having the core. Accordingly, deterioration in function of the antenna unit, which would be caused by deformation of the enclosure, can be reduced.

### BRIEF DESCRIPTION OF THE DRAWINGS

The object described above and other objects, features, as well as advantages will become clearer by suitable embodiments which will be described below and the following drawings pertaining to them.

FIG. 1 is a perspective view showing an example of an antenna unit according to a first embodiment of the present invention.

FIG. 2 is a top view of the antenna unit according to the first embodiment and an external circuit board connected to the antenna unit.

FIG. 3 is a partial magnified view of a region indicated by a dash-dotted line in FIG. 2.

FIG. 4 is a bottom view of the antenna unit according to the first embodiment and the external circuit board connected to the antenna unit.

FIG. 5 is a schematic view of a door handle according to the first embodiment when seen from a lateral surface of the antenna unit.

FIG. 6 is a partial magnified view showing the antenna unit and the external circuit board connected to the antenna unit in a region indicated by a dash-dotted line in FIG. 5.

FIG. 7A, FIG. 7B, and FIG. 7C are each partial magnified views of an antenna unit according to a second embodiment of the present invention and an external circuit board connected to the antenna unit when seen from above.

FIG. 8 is a partial magnified view of an antenna unit according to a modification of the present invention and an external circuit board connected to the antenna unit when seen from a lateral side.

### DETAILED DESCRIPTION

Various constituent elements of an antenna unit 10 and a door handle 100 of the present invention do not need to be individually independent presences, and it is allowed that a plurality of constituent elements be formed as one member, one constituent element be formed of a plurality of members, a certain constituent element be a portion of another constituent element, a portion of a certain constituent element and a portion of another constituent element be overlapped, and the like.

In addition, although a method for manufacturing the antenna unit 10 or the door handle 100 of the present invention or the like may be described using a plurality of steps described in sequence, the described order does not limit the order or timing in which the plurality of steps are executed. Thus, when the method is carried out, the order of the plurality of steps can be modified within a range in which there is no bottleneck in terms of content, and some or the whole of execution timings of the plurality of steps may be overlapped on one another.

Hereinafter, embodiments of the present invention will be described based on the drawings. In the respective drawings, corresponding constituent elements have the same reference characters allotted, and repeated description thereof will not be given as appropriate.

In the present embodiments, description will be given defining front-back, left-right, and up-down directions as shown in the drawings. However, they are specified for the sake of convenience in order to easily describe relative relationships among the constituent elements, and directions when a product that implements the present invention is manufactured or used will not be limited. In the present embodiment, the front-back direction matches a longitudinal direction of an antenna unit and a winding direction of an antenna. The left-right direction matches a width direction of the antenna unit. The up-down direction matches a height direction and a thickness direction of the antenna unit.

In addition, a plane referred to in the present invention means a shape physically formed into a plane as a target, and naturally does not need to be a geometrically perfect plane.

### First Embodiment

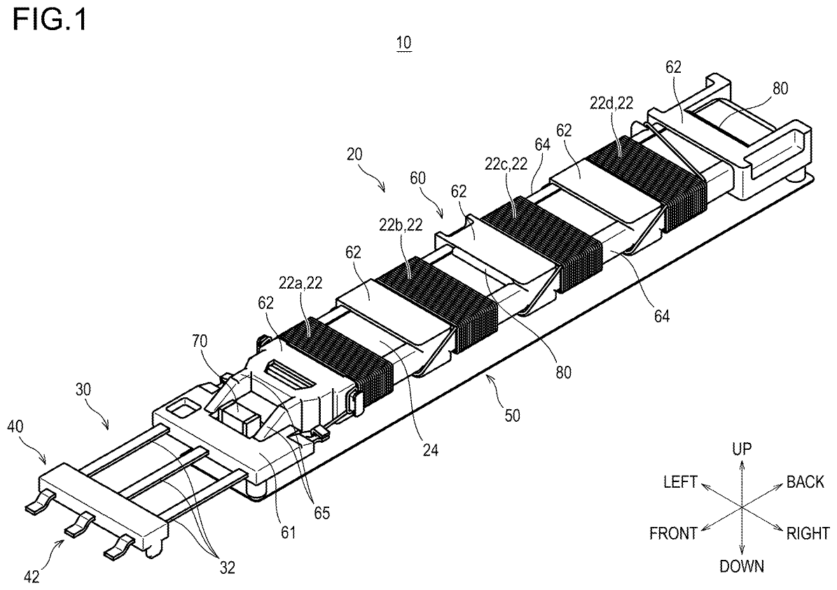

FIG. 1 is a plan schematic view showing an example of the antenna unit 10 according to a first embodiment of the present invention and the door handle 100 with the antenna unit 10 mounted thereon.

### Antenna Unit

First, an overview of the antenna unit 10 of the present embodiment will be described.

The antenna unit 10 is a long antenna unit 10 to be connected to an external circuit board (the circuit board 110). The antenna unit 10 has an antenna section 20 and a bendable section 30. In the antenna section 20, a coil wire 22 is wound around a core 24. The bendable section 30 can bend in a bending direction. The bending direction refers to a direction (for example, an up or down direction) intersecting a longitudinal direction (the front-back direction) of the antenna unit 10.

When a force is applied to the antenna unit 10 so as to bend the antenna unit 10 as a whole in one direction in the bending direction, the bendable section 30 can bend to a greater degree than the core 24 in the one direction.

Since the bendable section 30 can bend to a greater degree than the core 24 in the one direction in the bending direction, the bendable section 30 will bend prior to the core 24 when the antenna unit 10 is going to bend under stress with a direction in which the stress is applied to an enclosure such as of the door handle 100 and the above-described one direction being matched or substantially matched. Accordingly, cracking of the core 24, deformation of the antenna section 20 having the core 24, or the like is reduced. Accordingly, deterioration in function of the antenna unit 10, which would be caused by deformation of the enclosure, can be reduced.

Next, the antenna unit 10 of the present embodiment will be described in detail.

The antenna unit 10 is an electronic part that includes the antenna section 20 and may constitute a portion of an electronic circuit. In particular, the antenna unit 10 in the present embodiment is connected to the external circuit board 110 which will be described later via terminals 42 (input and output terminals and a proximity detection terminal) which will be described later to constitute a portion of an electronic circuit on the circuit board 110.

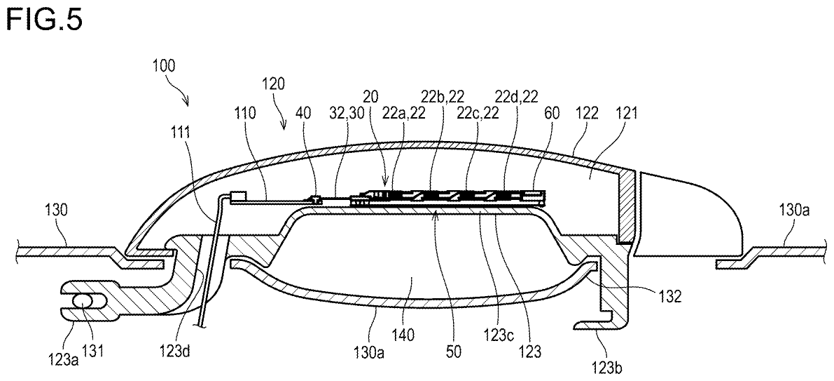

The antenna unit 10 in the present embodiment is incorporated in the door handle 100 (see FIG. 5) of a movable body such as a vehicle as will be described later. Thus, the antenna unit 10 (the antenna section 20) is a part which is long as a whole in the front-back direction. In addition, the antenna unit 10 (the antenna section 20) has a flattened shape as a whole. That is, a dimension of the antenna unit 10 (the antenna section 20) in the up-down direction is sufficiently smaller than a dimension of the antenna unit 10 (the antenna section 20) in the front-back direction and a dimension of the antenna unit 10 (the antenna section 20) in the left-right direction. Note that the directions including the up-down direction shown in the drawings may be different from directions when the antenna unit 10 is incorporated in the door handle 100. For example, the left-right direction shown in the drawings may substantially match the vertical direction when the antenna unit 10 is incorporated in the door handle 100.

The antenna unit 10 of the present embodiment may be incorporated in the door handle 100 in a door of a movable body which particularly adopts a keyless entry system. The antenna section 20 in the antenna unit 10 may transmit a request signal for authentication of an electronic key not shown in the drawing but carried by a user.

The antenna section 20 is a portion constituting an antenna in the antenna unit 10. Specifically, the coil wire 22 is wound around the core 24 in the antenna section 20 as described above. The coil wire 22 is wound with the longitudinal direction of the antenna unit 10 used as the winding direction.

In the present embodiment, the core 24 is formed of a magnetic material such as ferrite into a rod shape which is long in the front-back direction. The coil wire 22 is wound at a plurality of locations (in the present embodiment, four locations) at any positions in the longitudinal direction of the rod-shaped core 24. The plurality of locations, at which the coil wire 22 is wound, are spaced from one another in the longitudinal direction of the antenna unit 10. Accordingly, the coil wire 22 is wound over substantially the entire base portion 60 in the longitudinal direction of the antenna unit 10. The coil wire 22 is thus wound to be spaced from one another in the winding direction. By thus winding the coil wire 22 to be spaced from one another in the winding direction, a region in which the antenna senses a signal can be widened. In the present embodiment, while the antenna section 20 has one antenna, the antenna section 20 may instead have a plurality of antennas equal to or more than two. The plurality of antennas may be connected in series or may be connected in parallel.

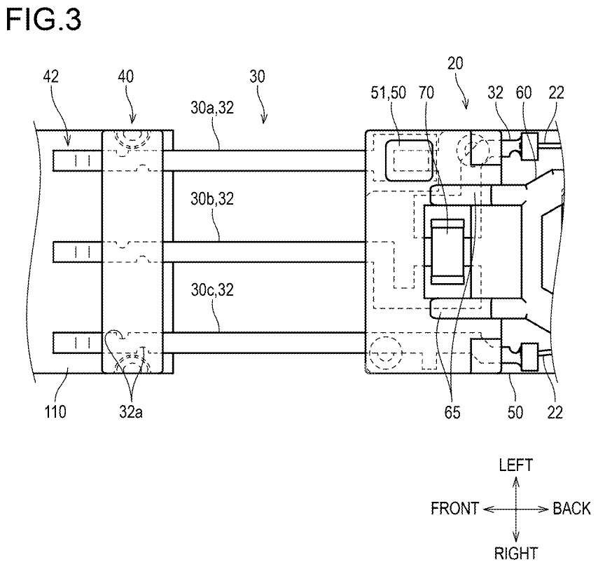

As shown in FIG. 3, both end portions of the coil wire 22 are drawn to the front side of the base portion 60 which will be described later. Both the end portions of the coil wire 22 are respectively connected to conductive plates 32 which will be described later. That is, the coil wire 22 is electrically connected to the terminals 42 via the conductive plates 32. In the present embodiment, the conductive plates 32 and the end portions of the coil wire 22 are connected by resistance welding, whereas they may be connected by brazing, such as soldering, or another method.

In the present embodiment, a chip capacitor 70 is arranged between a second bendable section 30b which will be described later and the coil wire 22. That is, the chip capacitor 70 is connected in series with the antenna. Electrodes of the chip capacitor 70 are connected to the conductive plates 32 exposed from the base portion 60 (a base end portion 61 which will be described later). The electrodes of the chip capacitor 70 and the conductive plates 32 are preferably bonded by brazing, such as soldering. Instead of the present embodiment, the antenna unit 10 may not have the chip capacitor 70.

As shown in FIG. 1, the antenna section 20 includes the base portion 60. In the present embodiment, the base portion 60 is formed of resin. The base portion 60 holds the core 24, around which the coil wire 22 is wound. Specifically, the base portion 60 is provided with a hollow extending in the front-back direction, and the core 24 is inserted in the hollow.

More specifically, the base portion 60 has a lateral portion 64 extending in the front-back direction and arranged in proximity to a lateral side of the core 24. An outside of the base portion 60 and the hollow in which the core 24 is arranged communicate on and under the base portion 60. Flange portions 62 protruding in the up-down direction are formed on the base portion 60. The base portion 60 has the plurality of flange portions 62. The plurality of flange portions 62 are arranged to be spaced in the front-back direction. The coil wire 22 is wound between the flange portions 62. In the present embodiment, an adhesive agent 80 reinforces fixture of portions of the core 24 to the base portion 60.

A front end portion (the base end portion 61) of the base portion 60 in the present embodiment has a more flattened shape than the flange portions 62 or the core 24. The conductive plates 32 are buried in the base end portion 61 as will be described later. Since the base end portion 61, in which the conductive plates 32 are buried, has a small thickness dimension in the bending direction, the base end portion 61 can follow deformation of the conductive plates 32 more flexibly than other portions of the base portion 60. Accordingly, unexpected folding of the conductive plates 32 or unexpected damage or deformation of the base portion 60 can be reduced.

The chip capacitor 70 is placed on the base end portion 61. Specifically, standing portions 65 aligned to be spaced in the left-right direction are formed on the base end portion 61. The standing portions 65 extend so as to intersect an upper surface of the base end portion 61 and have a predetermined height dimension in the up-down direction. The standing portions 65 keep the strength of the base portion 60 and protect the chip capacitor 70. The standing portions 65 in the present embodiment have an inclined surface descending from the back toward the front. That is, the height dimension of the standing portions 65 decreases from the back toward the front.

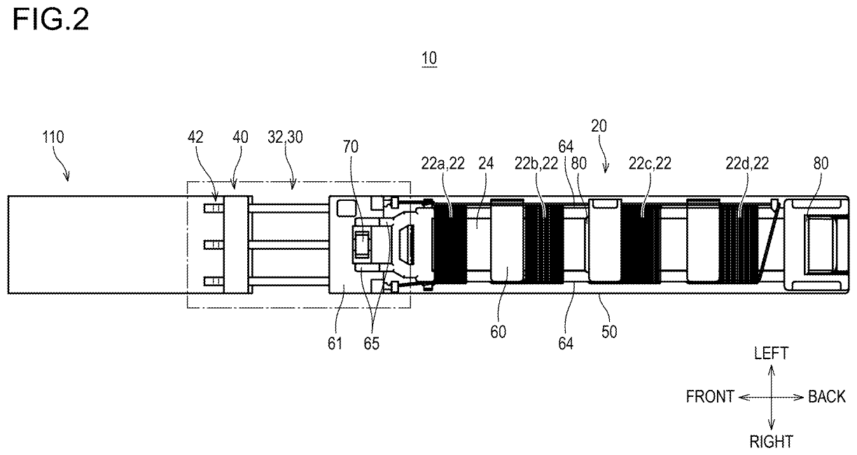

The circuit board 110 is a substrate which is disposed outside the antenna unit 10 and on which the electronic circuit to which the antenna unit 10 is connected is arranged. As shown in FIG. 2, the shape of the circuit board 110 is a plate shape extending in the front-back direction and the left-right direction.

As shown in FIG. 5, the electronic circuit on the circuit board 110 is connected to electric equipment (not shown in the drawing) arranged outside the door handle via a harness 111.

The bendable section 30 is a portion having bendability in the bending direction in the antenna unit 10. The bendability refers to a characteristic by which the member can bend when a predetermined force is applied to the member and by which the member can return to an original shape of the member when application of the predetermined force to the member is stopped. The term bend refers to curving of the whole or part of the bendable section 30. Preferably, the bendable section 30 is not folded back so as to locally inflect. The expression that the member can return to the original shape of the member does not require the member to return to the shape just the same as before the predetermined force is applied. For example, the member may have a shape which is slightly bent relative to the original shape of the member after the return. The predetermined force herein is a force to such a degree that one manually grips and pulls or manually pushes part or the whole of the antenna unit 10. Note that the predetermined force may be applied to the antenna unit 10 in a state stored in the enclosure (the door handle 100) which will be described later. Specifically, when a hand or the like is inserted into an insertion space 140 which is shown in FIG. 5 and which will be described later so that an inner member 123 is pulled toward the outside of the vehicle by the hand or the like, the predetermined force may be applied indirectly to the antenna unit 10 via the inner member 123.

The bending direction refers to a direction in which the antenna unit 10 has bendability. That is, the antenna unit 10 can bend so as to exhibit a shape protruding in one direction in the bending direction. Specifically, the bending direction is a direction intersecting, preferably orthogonal to, the longitudinal direction of the antenna unit 10. The bending direction in the present embodiment is the up or down direction. The bending direction may be a left or right direction or an oblique direction having an up-down direction component and a left-right direction component. In addition, the bending direction may be an oblique direction having a longitudinal direction component. That is, the bending direction may be an oblique direction having an up-down direction component and a longitudinal direction component, or may be an oblique direction having a left-right direction component and a longitudinal direction component. That is, the above-described one direction in which the antenna unit 10 bends is not limited to upward, downward, leftward, or rightward, and may be an oblique orientation. The expression that the bendable section 30 bends to a greater degree than the core 24 in the one direction in the bending direction is not limited to the bendable section 30 having bendability greater than that of the core 24 only in certain one direction (for example, only in the up-down direction), and the bendable section 30 may have bendability greater than that of the core 24 in each of a plurality of directions (for example, in the up-down direction and the left-right direction).

The one direction in which the antenna unit 10 bends in the present embodiment is, in the bending direction, an orientation toward the opposite side of a side where a proximity detection electrode 50 is arranged as seen from the antenna section 20. The one direction in which the antenna unit 10 in the present embodiment bends is upward. Instead of this, the antenna unit 10 may bend downward. The direction in which the predetermined force described above is applied substantially matches the one direction in which the antenna unit 10 bends.

As described above, when a force is applied to the antenna unit 10 so as to bend the antenna unit 10 as a whole in the one direction (in the present embodiment, upward) in the bending direction, the bendable section 30 can bend to a greater degree than the core 24 in the one direction. The expression that the antenna unit 10 bends as a whole refers to the antenna unit 10 having a shape curved with the bendable section 30, arranged at any position of the antenna unit 10 in the longitudinal direction of the long antenna unit 10, located at the center. When the antenna unit 10 bends as a whole, only the bendable section 30 may actually have bendability and may bend to be curved. In this case, a portion (for example, the antenna section 20) other than the bendable section 30 may have a linear shape as seen in the left-right direction.

In addition, places of the antenna unit 10 where the predetermined force is applied to the antenna unit 10 so as to bend the antenna unit 10 as a whole can include the bendable section 30, the antenna section 20, or the connector section 40 which will be described later, or a plurality of locations among them or all of the locations.

The expression that the bendable section 30 bends to a greater degree than the core 24 refers to, when the predetermined force is applied to the antenna unit 10, a radius of curvature at a central portion bent to the greatest degree of the bent bendable section 30 being smaller than a radius of curvature at a central portion bent or deformed to the greatest degree of the bent or slightly deformed core 24. Alternatively, the expression that the bendable section 30 bends to a greater degree than the core 24 refers to, when the predetermined force is applied to the antenna unit 10, an angle formed by respective extending directions of a portion and another portion between which the central portion bent to the greatest degree of the bent bendable section 30 is interposed being smaller than an angle formed by respective extending directions of a portion and another portion between which the central portion bent or deformed to the greatest degree of the bent or deformed core 24 is interposed. In a case in which the core 24 bends little or deforms little when the predetermined force is applied to the antenna unit 10, it may be assumed that the bendable section 30 is bent to a sufficiently greater degree than the core 24.

The bendable section 30 has bendability greater than that of the core 24. Preferably, the bendable section 30 has bendability greater than that of the base portion 60. In this case, the bendable section 30 can bend to a greater degree than the base portion 60 when the predetermined force is applied.

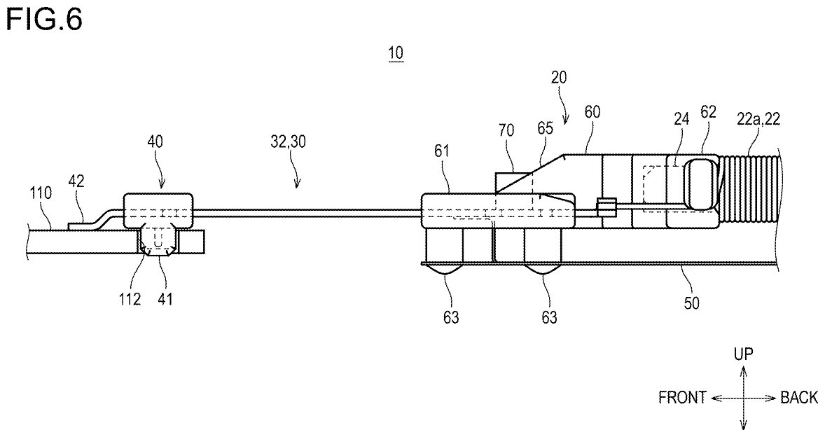

In the present embodiment, the bendable section 30 includes the conductive plates 32 as will be described later. More specifically, the bendable section 30 is composed of the three conductive plates 32 (a first bendable section 30a, a second bendable section 30b, and a third bendable section 30c) as shown in FIG. 3. Each of the conductive plates 32 extends in the width direction (the left-right direction) and the longitudinal direction (the front-back direction) of the antenna unit 10, and the three conductive plates 32 are aligned in the width direction. In addition, the three conductive plates 32 are arranged at substantially the same height in the up-down direction as shown in FIG. 6. Accordingly, the three conductive plates 32 can bend integrally when the predetermined force is applied to the antenna unit 10. In addition, since the three conductive plates 32 have torsional rigidity because of the above-described configuration, bending of the antenna unit 10 in an unexpected direction is reduced.

As shown in FIG. 3, a length dimension of the bendable section 30 in the front-back direction is larger than a width dimension of the bendable section 30 in the left-right direction (the width dimension of the bendable section 30 when all of the plurality of conductive plates 32 are seen as the one bendable section 30). Accordingly, the bendable section 30 can bend in the bending direction. In addition, the length dimension of the bendable section 30 in the front-back direction is smaller than the length dimension of the antenna section 20 in the front-back direction.

In the present embodiment, the bendable section 30 is a member different from the antenna section 20 including the base portion 60 and the coil wire 22, the connector section 40 and the proximity detection electrode 50 which will be described later, whereas this is not a limitation. For example, instead of the present embodiment, the bendable section 30 may be a portion of the base portion 60, a portion of the connector section 40, or a portion of the proximity detection electrode 50. More specifically, there are cases, for example, in which, instead of the present embodiment, the core 24 is divided and in which a plurality of antennas, each being formed by winding a coil wire around each of divided cores, are arranged to be spaced in the longitudinal direction. At this time, in the one base portion 60 holding the respective divided cores, portions arranged among the cores 24 may have bendability to be the bendable section 30.

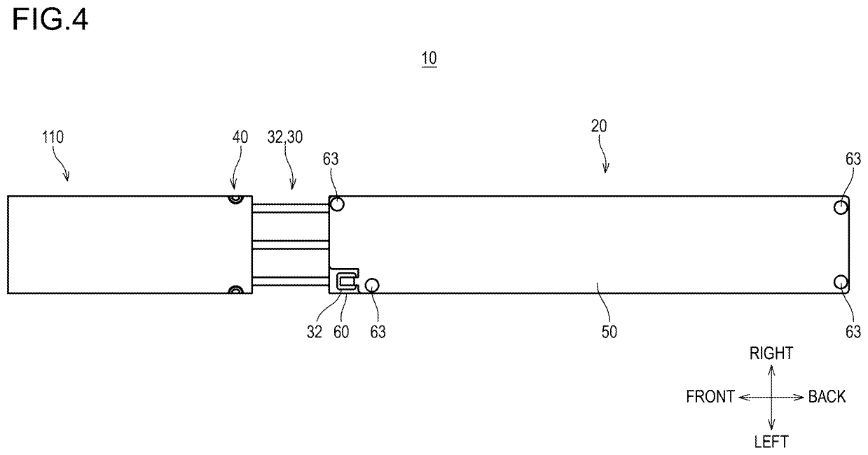

As shown in FIG. 1 or FIG. 4, the antenna unit 10 further has the proximity detection electrode 50. The proximity detection electrode 50 is an electrode for detecting that an object such as a hand or a finger is close to the antenna unit 10. The proximity detection electrode 50 in the present embodiment is a capacitance detection electrode that detects that a capacitance has changed. For example, when the proximity detection electrode 50 detects that an object such as a hand is close to, a lock of a door 130 is turned from a locked state to an unlocked state to allow the door 130 to be opened.

The proximity detection electrode 50 in the present embodiment is a plate-shaped member having a principal surface directed to the bending direction. The principal surface of the proximity detection electrode 50 is preferably directed to the direction (which is also a pulling direction which will be described later) in which the predetermined force is applied to the antenna unit 10. As described above, the predetermined force is applied to the antenna unit 10 in the bending direction. Thus, in the present embodiment, the principal surface of the proximity detection electrode 50 is directed to the bending direction.

As shown in FIG. 4 and FIG. 6, the proximity detection electrode 50 in the present embodiment is electrically connected to the conductive plates 32 to be connected to the circuit board 110. Specifically, as shown in FIG. 4, a portion (an exposed portion 51 in FIG. 3) of a surface (in particular, a lower surface) of the conductive plate 32 (the first bendable section 30a) buried in the base portion 60 is exposed from the base portion 60 at the underside of the base portion 60. A portion of the proximity detection electrode 50 comes into contact with the exposed surface of the conductive plate 32, so that the conductive plate 32 and the proximity detection electrode 50 are electrically connected. In the present embodiment, the conductive plate 32 and the proximity detection electrode 50 are soldered. Accordingly, an object being in close proximity is sensed via the circuit board 110.

As shown in FIG. 5 and FIG. 6, the proximity detection electrode 50 is arranged on a lower side of the antenna section 20 (the opposite side of the direction in which the antenna section 20 bends). Specifically, the proximity detection electrode 50 is arranged to be spaced from the lower surface of the base portion 60. More specifically, the base portion 60 has four support portions 63 at four corners of the lower surface, respectively, as shown in FIG. 4. As shown in FIG. 6, four corners of the proximity detection electrode 50 are fixed to the four support portions 63, respectively. In the present embodiment, the proximity detection electrode 50 is fixed to the base portion 60 while being grasped between portions (upper portions) and other portions (lower portions) of the support portions 63.

As shown in FIG. 1, the antenna unit 10 further has the connector section 40. The connector section 40 has fixed thereto the terminals 42 for connection to the circuit board 110 (see FIG. 2 to FIG. 4). The connector section 40 is arranged on an extension of the antenna section 20 in the longitudinal direction. The bendable section 30 is arranged between the antenna section 20 and the connector section 40 in the longitudinal direction of the antenna section 20. In other words, in the present embodiment, when the antenna unit 10 is viewed from the bending direction, the antenna section 20 is positioned at a location that does not overlap the circuit board 110. That is, the antenna section 20 is spaced from the circuit board 110 in a direction intersecting the bending direction, in particular, in the longitudinal direction of the antenna section 20.

By aligning the antenna section 20 and the connector section 40 in the longitudinal direction and providing the bendable section 30 between them, the antenna section 20 can be positioned outside the circuit board 110. Since the antenna section 20 is not placed on the circuit board 110, the circuit board 110 can be lessened. As a result, breakage of the circuit board 110 by being cracked itself, for example, which would be caused by deformation of the enclosure such as of the door handle, is reduced. Furthermore, breakage of the antenna unit 10 by being unexpectedly cracked, for example, between the circuit board 110 and the antenna section 20 is reduced by the bendable section 30.

The connector section 40 shown in FIG. 3 is a member for the antenna unit 10 to be coupled to the circuit board 110. The connector section 40 in the present embodiment holds one end portion (a front end portion) of the bendable section 30 and the terminals 42 as will be described later and is fixed to the circuit board 110. Accordingly, the terminals 42 are arranged on and connected to the circuit board 110.

The connector section 40 in the present embodiment is formed of resin. The connector section 40 may be formed of resin of the same material as the base portion 60 or may be formed by another material. Coupling protrusions 41 protruding downward are formed at left and right portions of the connector section 40. The coupling protrusions 41 are inserted (or press-fitted) into coupling recesses 112 provided in a back end portion of the circuit board 110. When the coupling protrusions 41 and the coupling recesses 112 are fitted together, the connector section 40 is coupled to the circuit board 110. Instead of the present embodiment, the connector section 40 may be coupled to the circuit board 110 by grasping the circuit board 110 in the up-down direction or the left-right direction, or the connector section 40 may adhere to the circuit board 110 by means of an adhesive agent.

As shown in FIG. 6, the expression that the connector section 40 is arranged on the extension of the antenna section 20 in the longitudinal direction (the front-back direction) of the antenna section 20 refers to at least a portion of the connector section 40 and at least a portion of the antenna section 20 being overlapped when seen in the longitudinal direction. Preferably, the bendable section 30, a portion of the connector section 40, and a portion of the antenna section 20 are overlapped on one another when seen in the longitudinal direction.

As described above, the antenna section 20 and the connector section 40 are arranged on both sides of the bendable section 30. The connector section 40 and the antenna section 20 (in particular, the base portion 60) arranged on both the sides of the bendable section 30 in the longitudinal direction are more rigid than the bendable section 30. Thus, when a force in the bending direction is applied to the antenna section 20 or the connector section 40, the force applied to the antenna section 20 or the base portion 60 is added to the bendable section 30, so that the bendable section 30 can bend prior to the antenna section 20 or the connector section 40.

In other words, in the present embodiment, the antenna section 20, the bendable section 30, and the connector section 40 are arranged in this order in the longitudinal direction of the antenna section 20. More specifically, when the antenna unit 10 is viewed in plan, that is, as seen from a direction intersecting the longitudinal direction of the antenna section 20, the center of the antenna section 20, the center of the bendable section 30, and the center of the connector section 40 are aligned in this order in the longitudinal direction of the antenna section 20.

The bendable section 30 is long in the longitudinal direction. In addition, the bendable section 30 has a principal surface directed to the bending direction. The bendable section 30 includes the conductive plates 32 (in particular, plates formed of metal such as copper) having a predetermined thickness in the bending direction. The bendable section 30 has flexural rigidity capable of supporting a dead weight of the connector section 40. Herein, the expression that the bendable section 30 has flexural rigidity capable of supporting the dead weight of the connector section 40 refers to the bendable section 30 having predetermined flexural rigidity. Herein, the predetermined flexural rigidity is, specifically, such a degree of flexural rigidity that in a case in which the antenna section 20 is fixed without the connector section 40 supported by a member other than the bendable section 30, the bendable section 30 holds a self-restoring force without being plastically deformed by inflection, for example, due to the dead weight of the connector section 40.

Preferably, the bendable section 30 has flexural rigidity capable of supporting dead weights of the connector section 40 and the circuit board 110 when the connector section 40 is coupled to the circuit board 110.

In the present embodiment, the bendable section 30 is composed of the plurality of (three) conductive plates 32. The plurality of conductive plates 32 constituting the bendable section 30 should only have the predetermined flexural rigidity described above as a whole. Only one of the conductive plates 32 constituting the bendable section 30 may have the predetermined flexural rigidity, so that the bendable section 30 may have the predetermined flexural rigidity as a whole. Alternatively, even if only one of the conductive plates 32 constituting the bendable section 30 does not have the predetermined flexural rigidity, the bendable section 30 may have the predetermined flexural rigidity as a whole because of the presence of the plurality of conductive plates 32.

In the present embodiment, the bendable section 30 is a partial length region of the conductive plates 32 protruding from the base portion 60 or the connector section 40. That is, the bendable section 30 is only a portion interposed between the base portion 60 and the connector section 40, and the bendable section 30 may not include portions of the conductive plates 32 buried in the base portion 60 or the connector section 40. Instead of the present embodiment, the portions of the conductive plates 32 buried in the base portion 60 or the connector section 40 may also be the bendable section 30 in addition to the portions of the conductive plates 32 arranged to be interposed between the base portion 60 and the connector section 40.

As shown in FIG. 3, both the ends of the bendable section 30 in the longitudinal direction are connected to the terminals 42 and one end portion of the antenna section 20, and the bendable section 30 constitutes at least a portion of a conductive channel which leads from the coil wire 22 to the terminals 42. That is, in the present embodiment, the bendable section 30 is an interconnect line portion. Specifically, as shown in FIG. 3, the front end portions of the bendable section 30 are connected to the terminals 42 buried in the connector section 40 at a back end of the connector section 40. In the embodiment, the bendable section 30 and the terminals 42 are formed of one member (the conductive plates 32). A boundary between the terminals 42 and the bendable section 30 in the conductive plates 32 is the back end of the connector section 40 (a rear surface of the connector section 40 directed to the back side). More specifically, the conductive plates 32 forming the bendable section 30 extend through the connector section 40 and protrude from the front side of the connector section 40. The terminals 42 are formed to protrude from the connector section 40 to the front side to be folded into a predetermined shape. The terminals 42 are formed as portions of the conductive plates 32 integrally with the bendable section 30. In a case in which portions of the conductive plates 32 buried in the connector section 40 are assumed as portions of the bendable section 30, the boundary between the terminals 42 and the bendable section 30 in the conductive plates 32 may be located inside the connector section 40. In this case, it can be said that the terminals 42 and the bendable section 30 are connected inside the connector section 40. Alternatively, instead of the present embodiment, the terminals 42 and the bendable section 30 may be formed of other members and may be electrically connected to each other directly or indirectly. In addition, back end portions of the bendable section 30 (the second bendable section 30b, the third bendable section 30c) are electrically connected to the coil wire 22 via the conductive plates 32 arranged inside the base portion 60. Note that a back end portion of the first bendable section 30a is connected to the proximity detection electrode 50 as will be described later.

In addition, the conductive plate 32 buried in the connector section 40 in the present embodiment has recessed shapes 32a hollowed toward the inside of the conductive plate 32 in the width direction of the conductive plate 32. More specifically, the conductive plate 32 has the recessed shapes 32a, one each on the left and right. The two recessed shapes 32a are arranged with a shift in the longitudinal direction, and a portion in which the recessed shape 32a is formed in the conductive plate 32 is thinner than another portion. Since the conductive plate 32 has the recessed shapes 32a described above, resin of the connector section 40 enters the recessed shapes 32a. As a result, the conductive plate 32 is rigidly fixed to the connector section 40.

As described above, since the bendable section 30 is a plate having a predetermined thickness and has flexural rigidity enough to support the dead weight of the connector section 40, assembly of the door handle 100 (such as arrangement in a housing 120 or bonding to the circuit board 110) is facilitated. Specifically, in the antenna unit 10 having the above-described configuration, the state in which the connector section 40, the bendable section 30, and the antenna section 20 are aligned in the longitudinal direction is kept even in a case in which the antenna section 20 and the like are held by hand, an instrument, or the like. Thus, in a case in which the terminals 42 are to be arranged at a desired position on the circuit board 110, in a case in which the antenna unit 10 is to be arranged at a desired position in the housing 120 which will be described later, or the like, the antenna unit 10 can be adjusted in position while the antenna section 20 is being held and moved. Furthermore, since the bendable section 30 has sufficient torsional rigidity because of the above-described configuration, it is still easier to arrange the antenna unit 10 at a desired position while the antenna section 20 is being held and moved.

As shown in FIG. 6, in the present embodiment, the thickness dimension of the bendable section 30 in the bending direction is larger than the thickness dimension of the proximity detection electrode 50 in the bending direction. Accordingly, the bendable section 30 can have the predetermined flexural rigidity described above. The thickness dimension of the bendable section 30 in the bending direction is smaller than the thickness dimension of the base portion 60 or the core 24 in the bending direction. Accordingly, the bendable section 30 has bendability.

In the present embodiment, the bendable section 30 is composed of the three conductive plates 32 aligned in the left-right direction. In the present embodiment, the three conductive plates 32 are arranged so as to be overlapped on one another as seen from a lateral side (in the left-right direction or the front-back direction). Thus, the thickness dimension of the bendable section 30 is equal to the thickness of each of the conductive plates 32. Instead of the present embodiment, in a case in which the three conductive plates 32 are respectively arranged at different positions in the up-down direction, the distance along the up-down direction from an upper surface of the conductive plate 32 arranged at the uppermost side to a lower surface of the conductive plate 32 arranged at the lowermost side is the thickness dimension of the bendable section 30.

As shown in FIG. 6, the bendable section 30 is laid between the one end portion of the antenna section 20 and the connector section 40. That is, the connector section 40 and the antenna section 20 (in particular, the base portion 60) are spaced in the longitudinal direction, and the bendable section 30 is arranged between the connector section 40 and the antenna section 20 as spaced. As described above, in the present embodiment, the bendable section 30 refers to only the portions of the conductive plates 32 that are arranged between the connector section 40 and the base portion 60. That is, the expression that the bendable section 30 is laid between the connector section 40 and the antenna section 20 refers to each of both the ends of the bendable section 30 being in contact with an end surface of the connector section 40 or the antenna section 20. Alternatively, both the ends of the bendable section 30 may not reach the end surface of the connector section 40 or the antenna section 20. That is, the bendable section 30 may be arranged between the connector section 40 and the base portion 60 without both the ends of the bendable section 30 coming into contact with the end surface of the connector section 40 or the antenna section 20 (to be spaced from the end surface). Instead of the present embodiment, in a case in which the portions of the conductive plates 32 that are buried in the connector section 40 or the base portion 60 are included in the bendable section 30, each of both the ends of the bendable section 30 may be hung so as to be overlapped on the connector section 40 or the antenna section 20 (the base portion 60) in the up-down direction.

Both the ends of the bendable section 30 in the longitudinal direction are connected to the connector section 40 and the antenna section 20. Specifically, the front end portions of the conductive plates 32 constituting the bendable section 30 are buried in the connector section 40 as described above. In addition, the back end portions of the conductive plates 32 constituting the bendable section 30 are buried in the base portion 60 as will be described later. In the present embodiment, the connector section 40 and the base portion 60 (the antenna section 20) are connected only with the bendable section 30. That is, other members different from the bendable section 30 in the antenna unit 10 is not arranged on and under the bendable section 30.

The proximity detection electrode 50 is arranged at a lower side of the one end portion (front end portion) of the antenna section 20 (the opposite side of the one direction in which the bendable section 30 bends in the bending direction). That is, the proximity detection electrode 50 extends to the lower side of a frontmost portion of the antenna section 20. In the present embodiment, a front end of the proximity detection electrode 50 and the front end of the antenna section 20 (in particular, the base portion 60) are located at substantially the same position in the front-back direction. In addition, a lowermost portion of the base portion 60 (in particular, the support portion 63) in the up-down direction is arranged below the position of a lowermost portion of the connector section 40 (a lower surface of the coupling protrusion 41). In other words, the position of the proximity detection electrode 50 in the up-down direction is arranged below the position of the lowermost portion of the connector section 40. In a case in which the circuit board 110 and the antenna unit 10 are coupled, the position of the proximity detection electrode 50 in the up-down direction is arranged below a lower surface of the circuit board 110.

With the above-described configuration, the bendable section 30 is arranged in the air between the antenna section 20 and the circuit board 110 spaced from each other when the antenna unit 10 is connected to the circuit board 110. Accordingly, the antenna unit 10 can be curved with the bendable section 30 located at the center.

As shown in FIG. 6, one end portion of (back end portion) of the conductive plate 32 is buried in the base end portion 61. The base end portion 61 is one end portion (front end portion) of the base portion 60 in the longitudinal direction. That is, the back end portion of the conductive plate 32 is surrounded by the base end portion 61 in the up-down direction and the left-right direction. The conductive plate 32 is in close contact with the surrounding base portion 60, as the base portion 60, in which the conductive plate 32 is buried, is formed by insert molding.

Since the conductive plate 32 is buried in the base end portion 61, the bendable section 30 is fixed to the base portion 60 so as to be grasped at least on both sides in the bending direction (the up or down direction). As a result, when the bendable section 30 bends in the bending direction, the state in which a proximal end portion of the bendable section 30 and the antenna section 20 are arranged in a line in the longitudinal direction is kept. Accordingly, folding of the bendable section 30 at the proximal end portion of the bendable section 30 is reduced.

In the present embodiment, the conductive plate 32 is interposed between a portion and another portion of the base end portion 61 in the up-down direction. A thickness dimension of the portion of the base end portion 61 that is arranged on the conductive plate 32 is smaller than a thickness dimension of the other portion of the base end portion 61 that is arranged under the conductive plate 32. In other words, the thickness dimension of the portion of the base end portion 61 that is arranged on the one-direction side (on the upper side) in which the bendable section 30 bends relative to the conductive plate 32 is larger than the thickness dimension of the other portion of the base end portion 61 that is arranged on the opposite side (the lower side) from the one-direction side relative to the conductive plate 32. Accordingly, the base end portion 61 can satisfactorily support the bendable section 30 when the bendable section 30 bends upward.

Note that in the present embodiment, the other end portion of the conductive plate 32 is buried in the connector section 40 as described above. That is, the front end portion of the conductive plate 32 is surrounded by the connector section 40 in the up-down direction and the left-right direction. The connector section 40, in which the conductive plate 32 is buried, is formed by insert molding. The conductive plate 32 is interposed between a portion and another portion of the connector section 40 in the up-down direction. A thickness dimension of the portion of the connector section 40 that is arranged on the conductive plate 32 is smaller than a thickness dimension of the other portion of the connector section 40 that is arranged under the conductive plate 32. In other words, the thickness dimension of the portion of the connector section 40 that is arranged on the one-direction side (on the upper side) in which the bendable section 30 bends relative to the conductive plate 32 is larger than the thickness dimension of the other portion of the connector section 40 that is arranged on the opposite side (the lower side) from the one-direction side relative to the conductive plate 32.

In the present embodiment, the bendable section 30, which is the conductive plate 32 (in particular, a portion of the conductive plate 32 that substantially bends as the bendable section 30, that is, a portion of the conductive plate 32 interposed between the antenna section 20 and the connector section 40), is arranged outside the base portion 60. More specifically, the portion of the conductive plate 32 that substantially bends as the bendable section 30 is arranged outside the base portion 60 when the antenna unit 10 is viewed in plan. More specifically, the portion of the conductive plate 32 that substantially bends as the bendable section 30 does not overlap the base portion 60 as seen from a direction (in particular, the bending direction) intersecting the longitudinal direction of the antenna section 20.

### Door Handle

Next, the door handle 100 of the present embodiment will be described. The antenna unit 10 may be provided in a state built in the door handle 100.

An overview of the door handle 100 in the present embodiment will be described below.

The door handle 100 is a door handle to be provided for the door 130 of a movable body such as a vehicle body and to be pulled in a predetermined pulling direction to allow the door 130 to be opened. For example, a user of the movable body pulls the door handle in the pulling direction at a predetermined force to open the door 130. Herein, the pulling direction substantially matches the bending direction of the antenna unit 10.

As shown in FIG. 5, the door handle 100 has the circuit board 110, the antenna unit 10 described above, and the housing 120. The housing 120 houses the circuit board 110 and the antenna unit 10.

As described above, when a force is applied to the antenna unit 10 so as to bend the antenna unit 10 as a whole in one direction in the bending direction, the bendable section 30 can bend to a greater degree than the core 24 in the one direction.

The door handle 100 will be described in detail.

The door handle 100 is attached to the door 130. The upper side in the drawing of FIG. 5 is the outside of the door 130 (vehicle), and the lower side in the drawing is the inside of the door 130 (vehicle).

The housing 120 is an enclosure having a housing space 121 therein. The circuit board 110 and the antenna unit 10 are housed in the housing space 121. The housing space 121 in the present embodiment is defined by two members (an outer member 122 and an inner member 123).

Both end portions of the inner member 123 are inserted in the door 130. A rotatably supported portion 123a rotatably supported by a shaft portion 131 in the door 130 is formed at one end portion of the inner member 123. An engaging portion 123b is formed at the other end portion of the inner member 123. A stopper portion 132 is formed in an outer surface portion 130a constituting an outer surface of the door 130. The shape of the stopper portion 132 corresponds to the shape of the engaging portion 123b, and the stopper portion 132 can be engaged with the engaging portion 123b. Accordingly, the stopper portion 132 is engaged with the engaging portion 123b when the door handle 100 is pulled and swung. As a result, swinging of the door handle 100 relative to the door 130 is restricted.

An interconnect line passage 123d that causes a space on the inner side and a space on the outer side of the outer surface portion to communicate with each other is formed in a portion in the vicinity of the rotatably supported portion 123a in the inner member 123. Various interconnect lines (including the harness 111) are installed through the interconnect line passage 123d from the space on the inner side (the lower side in FIG. 5) relative to the outer surface portion 130a to the space on the outer side (the upper side in FIG. 5).

The outer member 122 and the inner member 123 have shapes curved in an arc toward the outer side (the upper side in the drawing) of the vehicle body. Thus, the housing space 121 also has a shape curved in an arc toward the outer side of the vehicle body. A space (the insertion space 140) in which one can insert his/her hand is formed between the inner member 123 and the outer surface portion 130a.

In the present embodiment, the antenna unit 10 and the circuit board 110 are fixed to the inside of the door handle 100. The antenna unit 10 is arranged such that the lower surface of the proximity detection electrode 50 is directed to the insertion space 140. Accordingly, the pulling direction in which the door handle 100 is pulled and the bending direction of the antenna unit 10 substantially match.

The antenna unit 10 is fixed to the inner member 123. More specifically, tapes (not shown in the drawing) having adhesive layers arranged on both surfaces may be arranged between at least a portion of the lower surface (the surface directed to the lower side in the drawing) of the proximity detection electrode 50 and the inner member 123 and between at least a portion of the lower surface (the surface directed to the lower side in the drawing) of the connector section 40 and the inner member 123. Accordingly, the antenna unit 10 and the circuit board 110 are fixed to the inner member 123 by means of the tapes.

In addition, the housing space 121 is preferably filled with resin such as urethane. The resin may enter around the circuit board 110, around the antenna unit 10, and a space (such as a clearance between the proximity detection electrode 50 and the base portion 60) in the antenna unit 10. Accordingly, the antenna unit 10 and the circuit board 110 are fixed in position inside the door handle 100 with the resin. Note that the resin, which fills the housing space 121, preferably has predetermined flexibility. Herein, the predetermined flexibility is flexibility to such a degree that the bendable section 30 can hold bendability greater than that of the core 24 even if the resin is arranged around the bendable section 30 while being in contact with the bendable section 30. Accordingly, the bendable section 30 has sufficient bendability even if the antenna unit 10 is fixed to the door handle 100, which enables deformation and the like of the antenna unit 10 to be reduced.

As shown in FIG. 5, the insertion space 140 extends in the same direction as the longitudinal direction of the antenna unit 10 (the left-right direction in the drawing). The proximity detection electrode 50 is arranged along a space wall portion 123c. The space wall portion 123c is, in the inner member 123, a portion that defines the insertion space 140 and extends in the left-right direction in the drawing. Preferably, the proximity detection electrode 50 is arranged in proximity to or in contact with the space wall portion 123c. Specifically, the proximity detection electrode 50 is in more proximity to the insertion space wall portion 123c than the lower surface of the base portion 60. Accordingly, the proximity detection electrode 50 can satisfactorily detect that an object is inserted into the insertion space 140 and the object is close to the inner member 123. The expression that the member is along the insertion space wall portion 123c refers to an extending direction of the member and an extending direction of the insertion space wall portion 123c being substantially equal. Preferably, the member and the insertion space wall portion 123c are arranged adjacent to each other.

In addition, the bendable section 30 is preferably arranged along the insertion space wall portion 123c as shown in FIG. 5. Accordingly, the antenna unit 10 can satisfactorily bend with the bendable section 30 located at the center when a predetermined force is applied to the inner member 123.

As described above, the bendable section 30 is laid between the one end portion of the antenna section 20 and the connector section 40. As seen in the bending direction, the one end portion of the antenna section 20 and the circuit board 110 are spaced in the longitudinal direction of the antenna section 20 (the left-right direction in FIG. 5). That is, the circuit board 110 and the antenna section 20 are coupled by the bendable section 30. In more detail, it can be said that the circuit board 110 and the antenna section 20 are not only coupled by the bendable section 30 but also coupled by the space wall portion 123c. This is because the circuit board 110 and the antenna section 20 are each fixed to the space wall portion 123c.

When one pulls the door handle 100 with his/her hand or the like inserted in the insertion space 140, a force toward the outer side (the upper side in FIG. 5) of the vehicle is applied to the inner member 123, so that the door handle 100 (in particular, the inner member 123) may deform. In the present embodiment, the circuit board 110 and the proximity detection electrode 50 are fixed to the inner member 123 by means of the tapes as described above. Thus, the antenna unit 10 and the circuit board 110 may deform in association with deformation of the inner member 123 and the like. Since the bendable section 30 is laid between the circuit board 110 fixed to the inner member 123 and the proximity detection electrode 50 (fixed to the antenna section 20), the circuit board 110 and the antenna section 20 can bend as a whole with the bendable section 30 located at the center.

### Second Embodiment

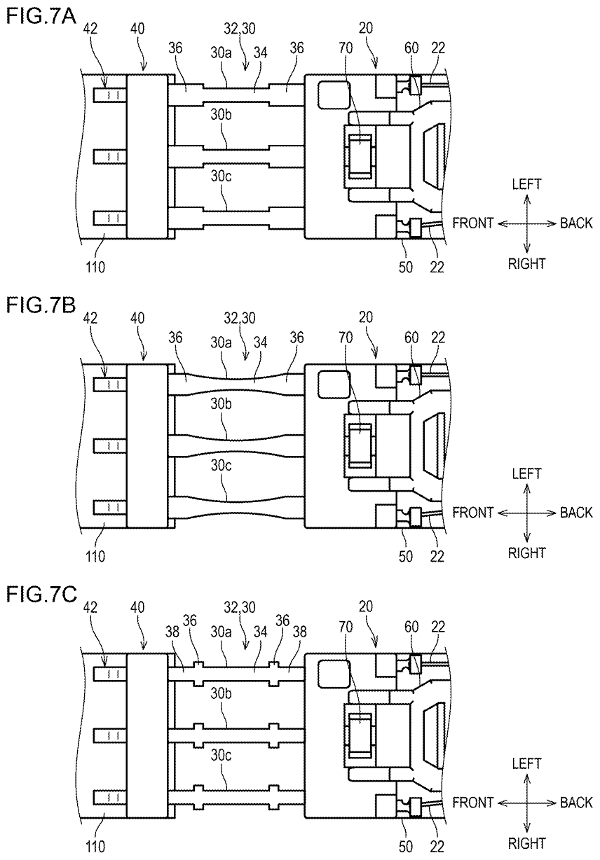

FIG. 7A to FIG. 7C are plan views showing examples of the antenna unit 10 according to the present embodiment.

First, an overview of the antenna unit 10 of the present embodiment will be described.

The antenna unit 10 of the present embodiment differs from the first embodiment in terms of the shape of the bendable section. Specifically, the antenna unit 10 of the present embodiment is characterized in that end regions 36 in more proximity to one end of the bendable section 30 in the longitudinal direction than a central portion 34 in the longitudinal direction are wider than the central portion 34. In the present embodiment, the two end regions 36 respectively located in proximity to both ends in the longitudinal direction are both wider than the central portion 34.

With the above-described configuration, the bendable section 30 is easier to bend at the narrow central portion 34 than at the end regions 36. Since the bendable section 30 bends with the central portion 34 of the bendable section 30 located at the center, loads are unlikely to be applied to both the end portions (proximal end portions) of the bendable section 30, which reduces unexpected folding of the bendable section 30 at both the ends (proximal ends).

The antenna unit 10 in the present embodiment is different from the first embodiment in terms of the shape of the bendable section 30. Other features of the antenna unit 10 in the present embodiment are common to the features of the antenna unit 10 of the first embodiment.

Specifically, the bendable section 30 has bendability capable of bending in the bending direction. When a force is applied to the antenna unit 10 so as to bend the antenna unit 10 as a whole in one direction in the bending direction, the bendable section 30 can bend to a greater degree than the core 24 in the one direction.

The bendable section 30 is arranged between the antenna section 20 and the connector section 40 in the longitudinal direction of the antenna section 20.

In addition, the bendable section 30 has flexural rigidity capable of supporting the dead weight of the connector section 40.

The thickness dimension of the bendable section 30 in the bending direction is larger than the thickness dimension of the proximity detection electrode 50 in the bending direction.

The proximity detection electrode 50 is arranged at a lower side (the opposite side of the one direction in which the bendable section 30 bends in the bending direction) of the one end portion (front end portion) of the antenna section 20.

The one end portions (back end portions) of the conductive plates 32 are buried in the base end portion 61.

Next, the antenna unit 10 of the present embodiment will be described in detail.

The end regions 36, the central portion 34, and one end portions 38 which will be described later are portions of the bendable section 30. More specifically, the end regions 36, the central portion 34, and the one end portions 38 are also partial length regions of the bendable section 30 extending in the longitudinal direction (the front-back direction). The central portion 34 may be or may not be located at the exact center of the bendable section 30 in the front-back direction and a vicinity thereof. For example, the central portion 34 may be located at a position slightly in proximate to the one end portion of the bendable section 30 from the exact center of the bendable section 30 in the front-back direction and may be located at the vicinity of that position.

As shown in FIG. 7A, a dimension in the width direction of the bendable section 30 may be abruptly varied at the boundary between the central portion 34 and the end region 36. In other words, the central portion 34 and the end region 36 each have a length region having a uniform width. The length region having a uniform width in the central portion 34 and the length region having a uniform width in the end region 36 are arranged adjacent to each other in the longitudinal direction.

Alternatively, as shown in FIG. 7B, the bendable section 30 may be changed so as to have a gradually thinner width in a region (transition region) which transitions from the end region 36 to the central portion 34.

Alternatively, as to the bendable section 30 in the present embodiment, the one end portion 38 in more proximity to one end than the end region 36 may be narrower than the end region 36 as shown in FIG. 7C. In more detail, the one end portion 38 and a portion of the conductive plate 32 which is continuous from the one end portion 38 and buried in the connector section 40 or the base portion 60 are narrower than the end region 36.

In a case in which portions of the most proximal end of the bendable section 30 are wide, a large load may be imposed on the connector section 40 or the base portion 60 in which the conductive plates 32 constituting the bendable section 30 are buried when the bendable section 30 bends. Since the one end portion 38 is narrow, application of a large load to the connector section 40 or the base portion 60 can be reduced. As a result, breaking or deformation of the connector section 40 or the base portion 60 in the case in which the bendable section 30 bends is reduced.

In the present embodiment, the length dimension of the end region 36 in the front-back direction is smaller than the length dimension of the one end portion 38 or the central portion 34 in the front-back direction. Accordingly, the wide length regions in the bendable section 30 can have a minimum length, which can sufficiently ensure bendability of the bendable section 30. In addition, the length dimension of the one end portion 38 in the front-back direction is smaller than the length dimension of the central portion 34 in the front-back direction. Since the central portion 34 has a sufficient length dimension, bendability of the bendable section 30 can be ensured.

Note that the present invention is not limited to the embodiments described above and includes aspects of various modifications, alterations, and the like as long as the object of the present invention is achieved.

The following modification examples can be combined as appropriate.

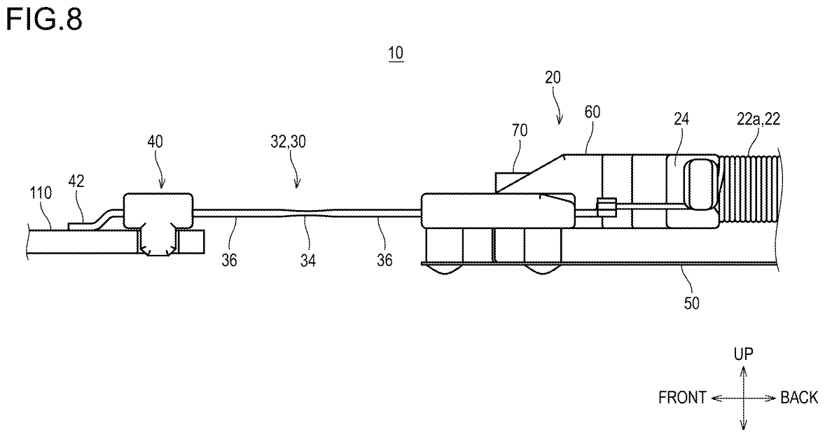

Although the bendable section 30 has a uniform thickness dimension in the first embodiment or the second embodiment, this is not a limitation. In the first embodiment or the second embodiment, the thickness dimension of the central portion 34 in the bending direction may be smaller than the thickness dimension of the end regions 36 in the bending direction as shown in FIG. 8. Since the central portion 34 of the bendable section 30 is thin, the central portion 34 can have larger bendability.

In the present embodiment, each of the upper surface and the lower surface of the bendable section 30 in the central portion 34 is hollowed toward the inside of the bendable section 30, so that the central portion 34 has a small thickness dimension. Instead of the present embodiment, only either the upper surface or the lower surface of the bendable section 30 in the central portion 34 may be hollowed toward the inside of the bendable section 30, so that the central portion 34 may have a small thickness dimension.

The bendable section 30 in the first embodiment and the second embodiment has the plurality of (three) conductive plates 32 aligned in the left-right direction. Instead of this, the bendable section 30 may be formed by one wide plate-shaped member. The wide plate-shaped member may be a member having a mesh shape or may be a flat plate.

In addition, the bendable section 30 is the interconnect line portion constituting the electronic circuit in the first embodiment and the second embodiment, whereas this is not a limitation. For example, the bendable section 30 may be formed of a non-conductive plate-shaped member. In this case, a conductive wire for connecting the terminals 42 and the coil wire 22 may be arranged along the plate-shaped member.

The above-described embodiments encompass the following technical ideas.
(1) An antenna unit which is long and is to be connected to an external circuit board, the antenna unit comprising:
   an antenna section in which a coil wire is wound around a core; and
   a bendable section capable of bending in a bending direction intersecting a longitudinal direction of the antenna unit, wherein
   when a force is applied to the antenna unit so as to bend the antenna unit as a whole in one direction in the bending direction, the bendable section can bend to a greater degree than the core in the one direction.
(1-1) The antenna unit wherein a length dimension of the bendable section in the longitudinal direction is larger than a width dimension of the bendable section in a width direction of the antenna unit.
(2) The antenna unit according to (1), further comprising a connector section to which a terminal for connection to the external circuit board is fixed, wherein
   the connector section is arranged on an extension of the antenna section in the longitudinal direction, and
   the bendable section is arranged between the antenna section and the connector section in the longitudinal direction.
(3) The antenna unit according to (2), wherein
   the bendable section is long in the longitudinal direction, is a conductive plate having a principal surface directed to the bending direction and having a predetermined thickness in the bending direction, and has flexural rigidity capable of supporting a dead weight of the connector section, and
   the bendable section constitutes at least a portion of a conductive channel which leads from the coil wire to the terminal with both ends of the bendable section in the longitudinal direction being connected to the terminal and one end portion of the antenna section.
(4) The antenna unit according to (3), further comprising a proximity detection electrode having a plate shape, being arranged on an opposite-direction side in the bending direction in the antenna section, and having a principal surface directed to the bending direction, wherein
   the bendable section is laid between the one end portion of the antenna section and the connector section, and
   the proximity detection electrode is arranged on the opposite-direction side of the one end portion of the antenna section in the bending direction.
(4-1) The antenna unit wherein the position of the proximity detection electrode in the up-down direction is arranged below the position of a lowermost portion of the connector section.
(5) The antenna unit according to (4), wherein
   the antenna section includes a base portion that holds the core, the coil wire being wound around the base portion, and
   one end portion of the conductive plate is buried in one end portion of the base portion in the longitudinal direction.
(5-1) The antenna unit wherein a thickness dimension of a portion of a base end portion that is arranged toward the one direction in which the bendable section bends relative to the conductive plate is larger than a thickness dimension of another portion of the base end portion that is arranged on the opposite side from the one direction relative to the conductive plate.
(5-2) The antenna unit wherein a thickness dimension of the one end portion of the base portion in which the conductive plate is buried is smaller than a thickness dimension of another portion of the base portion.
(6) The antenna unit according to (4) or (5), wherein a thickness dimension of the bendable section in the bending direction is larger than a thickness dimension of the proximity detection electrode in the bending direction.
(6-1) The antenna unit wherein the thickness dimension of the bendable section in the bending direction is smaller than a thickness dimension of the base portion or the core in the bending direction.
(7) The antenna unit according to any one of (2) to (6), wherein in the bendable section, an end region in more proximity to one end in the longitudinal direction than a central portion in the longitudinal direction is wider than the central portion.
(8) The antenna unit according to (7), wherein in the bendable section, one end portion in more proximity to the one end than the end region is narrower than the end region.
(8-1) The antenna unit wherein a length dimension of the end region in the front-back direction is smaller than a length dimension of the one end portion or the central portion in the front-back direction.
(8-2) The antenna unit wherein the length dimension of the one end portion in the front-back direction is smaller than the length dimension of the central portion in the front-back direction.
(9) The antenna unit according to any one of (1) to (8), wherein
   the bendable section has a central portion in the longitudinal direction, and
   a thickness dimension of the central portion in the bending direction is smaller than a thickness dimension in the bending direction of a portion in more proximity to one end in the longitudinal direction than the central portion in the bendable section.
(10) A door handle to be provided for a door and to be pulled in a pulling direction which is predetermined to allow the door to be opened, the door handle comprising:
   a circuit board;
   an antenna unit which is long and is connected to the circuit board; and
   a housing that houses the circuit board and the antenna unit, wherein
   the antenna unit includes
      an antenna section in which a coil wire is wound around a core, and
      a bendable section capable of bending in a bending direction intersecting a longitudinal direction of the antenna unit, and
   when a force is applied to the antenna unit so as to bend the antenna unit as a whole in one direction in the bending direction, the bendable section can bend to a greater degree than the core in the one direction.
(10-1) The door handle wherein
   an insertion space arranged between the door handle and the door extends in the longitudinal direction of the antenna unit,
   a proximity detection electrode is arranged along a space wall portion which is a portion defining the insertion space in an inner member and extending in the longitudinal direction of the antenna unit.
(10-2) The door handle wherein the bendable section is arranged along the insertion space wall portion.
(11) The door handle according to (10), wherein
   the antenna unit further includes a connector section to which a terminal for connection to the circuit board is fixed,
   the connector section is arranged on an extension of the antenna section in the longitudinal direction, and
   the bendable section is arranged between the antenna section and the connector section in the longitudinal direction.
(12) The door handle according to (11), wherein
   the bendable section is long in the longitudinal direction and is a conductive plate having a principal surface directed to the bending direction and having a predetermined thickness in the bending direction,
   the bendable section constitutes at least a portion of a conductive channel which leads from the coil wire to the terminal with both ends of the bendable section in the longitudinal direction being connected to the terminal and one end portion of the antenna section,
   the antenna unit has a proximity detection electrode having a plate shape, being arranged on an opposite-direction side in the bending direction in the antenna section, and having a principal surface directed to the bending direction,
   the bendable section is laid between the one end portion of the antenna section and the connector section, and
   the one end portion of the antenna section and the circuit board are spaced in the longitudinal direction as seen in the bending direction.

1. An antenna unit which is long and is to be connected to an external circuit board, the antenna unit comprising:
an antenna section in which a coil wire is wound around a core; and
a bendable section capable of bending in a bending direction intersecting a longitudinal direction of the antenna unit, wherein
when a force is applied to the antenna unit so as to bend the antenna unit as a whole in one direction in the bending direction, the bendable section can bend to a greater degree than the core in the one direction.

2. The antenna unit according to claim 1, further comprising a connector section to which a terminal for connection to the external circuit board is fixed, wherein
the connector section is arranged on an extension of the antenna section in the longitudinal direction, and
the bendable section is arranged between the antenna section and the connector section in the longitudinal direction.

3. The antenna unit according to claim 2, wherein
the bendable section is long in the longitudinal direction, is a conductive plate having a principal surface directed to the bending direction and having a predetermined thickness in the bending direction, and has flexural rigidity capable of supporting a dead weight of the connector section, and
the bendable section constitutes at least a portion of a conductive channel which leads from the coil wire to the terminal with both ends of the bendable section in the longitudinal direction being connected to the terminal and one end portion of the antenna section.

4. The antenna unit according to claim 3, further comprising a proximity detection electrode having a plate shape, being arranged on an opposite-direction side in the bending direction in the antenna section, and having a principal surface directed to the bending direction, wherein
the bendable section is laid between the one end portion of the antenna section and the connector section, and
the proximity detection electrode is arranged on the opposite-direction side of the one end portion of the antenna section in the bending direction.

5. The antenna unit according to claim 3, wherein
the antenna section includes a base portion that holds the core, the coil wire being wound around the base portion, and
one end portion of the conductive plate is buried in one end portion of the base portion in the longitudinal direction.

6. The antenna unit according to claim 4, wherein a thickness dimension of the bendable section in the bending direction is larger than a thickness dimension of the proximity detection electrode in the bending direction.

7. The antenna unit according to claim 2, wherein in the bendable section, an end region in more proximity to one end in the longitudinal direction than a central portion in the longitudinal direction is wider than the central portion.

8. The antenna unit according to claim 7, wherein in the bendable section, one end portion in more proximity to the one end than the end region is narrower than the end region.

9. The antenna unit according to claim 1, wherein
the bendable section has a central portion in the longitudinal direction, and
a thickness dimension of the central portion in the bending direction is smaller than a thickness dimension in the bending direction of a portion in more proximity to one end in the longitudinal direction than the central portion in the bendable section.

10. A door handle to be provided for a door and to be pulled in a pulling direction which is predetermined to allow the door to be opened, the door handle comprising:
a circuit board;
an antenna unit which is long and is connected to the circuit board; and
a housing that houses the circuit board and the antenna unit, wherein
the antenna unit includes
an antenna section in which a coil wire is wound around a core, and
a bendable section capable of bending in a bending direction intersecting a longitudinal direction of the antenna unit, and
when a force is applied to the antenna unit so as to bend the antenna unit as a whole in one direction in the bending direction, the bendable section can bend to a greater degree than the core in the one direction.

11. The door handle according to claim 10, wherein
the antenna unit further includes a connector section to which a terminal for connection to the circuit board is fixed,
the connector section is arranged on an extension of the antenna section in the longitudinal direction, and
the bendable section is arranged between the antenna section and the connector section in the longitudinal direction.

12. The door handle according to claim 11, wherein
the bendable section is long in the longitudinal direction and is a conductive plate having a principal surface directed to the bending direction and having a predetermined thickness in the bending direction,
the bendable section constitutes at least a portion of a conductive channel which leads from the coil wire to the terminal with both ends of the bendable section in the longitudinal direction being connected to the terminal and one end portion of the antenna section,
the antenna unit has a proximity detection electrode having a plate shape, being arranged on an opposite-direction side in the bending direction in the antenna section, and having a principal surface directed to the bending direction,
the bendable section is laid between the one end portion of the antenna section and the connector section, and
the one end portion of the antenna section and the circuit board are spaced in the longitudinal direction as seen in the bending direction.
